(19) United States
(12) Patent Application Publication
(10) Pub. No.: US 2006/0186197 A1
(43) Pub. Date: Aug. 24, 2006

(54) METHOD AND APPARATUS FOR WIRELESS CUSTOMER INTERACTION WITH THE ATTENDANTS WORKING IN A RESTAURANT

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, Pismo Beach, CA (US)

(21) Appl. No.: 11/422,065

(22) Filed: Jun. 2, 2006

Related U.S. Application Data
(60) Provisional application No. 60/691,692, filed on Jun. 16, 2005.

(51) Int. Cl. G06K 5/00; G06F 17/00; G06Q 30/00

(52) U.S. Cl. 235/380; 235/375; 705/15

(57) ABSTRACT

An apparatus and method are disclosed of a wireless system for customers to interact with attendants (e.g waiters) in restaurants. The system provides for a computing system that transmits electronic menus to wireless portable digital assistants (PDA's) and enables customers to place orders and make real-time service requests. For example, the customer is able to select food items from the menus, indicate preparation instructions for each food item, send comments to the attendants, and request drink refills. The customer is able to check on the status of food preparation via the PDA and observe the food being prepared by a camera link. Upon finishing the meal the restaurant can transmit an electronic bill to the customer.

This application claims benefit under 35 U.S.C. § 119(e) to U.S. Provisional Application No. 60/691,692 filed Jun. 16, 2005.

### BACKGROUND OF THE INVENTION

1. Field of the Invention

The present invention relates generally to methods and apparatus for enabling one or more customers to engage in wireless interactions with the waiters and/or other workers of a restaurant, the one or more customers using wireless computing devices within the restaurant to communicate with a restaurant computer or computers.

2. Discussion of the Related Art

Prior work has been done in the field of restaurant supported computing systems including the work disclosed in US Patent Application Publication No. 2005/0114149, which is hereby incorporated by reference.

Many people eat out at restaurants on a regular basis and some people go out to eat multiple times each week. When going to popular restaurants, a customer often waits in line for a table or makes reservations in advance and then waits for that reservation to be honored. This wait may vary from a few minutes to a few hours depending on the popularity of the restaurant and whether or not reservations are taken and honored. In some cases, customers will enter the restaurant, be seated at a table and wait there for a long time before ordering food.

In many cases the customer will order food and wait a long time for it to be served, wait a long time between courses, wait a long time for a check to be brought once the meal is completed, wait a long time for drink refills, and/or wait a long time for other services to be provided by the attendant. In many restaurant situations, especially at popular locations, the customer may often have to wait much longer than desired.

Furthermore, numerous people must be employed to take orders, tell customers the daily specials. Also, these restaurant employees must update customers as food is being prepared (especially if the delay is long), check on customers to see if drink refills are necessary, bring a bill to a customer, pick up the bill and process a credit card or bring change. While customers are eating the employees must also, check with customers at times throughout the meal to make sure so other action is necessary such as getting ketchup or bringing fresh silverware if an item has been dropped on the floor.

Even with a large staff, customers are often forced to wait for some or all of these customer/server interactions to be completed. This can make ordering food, waiting for food, getting drink refills, getting a check, and/or getting change from a payment in a restaurant a time consuming and frustrating experience for a customer. Conversely, for restaurants that are heavily staffed to ensure wait times are low, another problem often occurs—when the restaurant is not busy with customers there are employees standing idle.

What is needed is a better way to enable interaction between customers and servers to decrease wait times, increase productivity, reduce staffing burden, and improve the overall experience for customers of restaurants.

Therefore, it would be advantageous to have an improved method, apparatus, and computer instructions for customer/server interaction within restaurants.

### BRIEF DESCRIPTION OF THE DRAWINGS

Preferred embodiments of the invention will be described in conjunction with the following drawings, in which:

FIG. 1 is a network data processing system in which the present invention is implemented; and

FIG. 2 is a block diagram of a data processing system that may be implemented as a server in accordance with a preferred embodiment of the present invention; and

FIG. 3 is a diagram of a wireless device in the form of a personal digital assistant (PDA) in accordance with a preferred embodiment of the present invention; and

FIG. 4 is a diagram illustrating the components used in enabling customer interactions with restaurant; and

FIG. 5 is a flowchart depicting the downloading of data from the server; and

FIG. 6 is a pictorial view of the PDA screen showing the downloaded menu; and

FIG. 7 is a flowchart of the menu selection process from the PDA; and

FIG. 8 is a pictorial view of the PDA screen showing the restaurant bill; and

FIG. 9 is a pictorial view of the PDA screen showing the service requests currently pending for the user; and

FIG. 10 is a block diagram of the camera link system for viewing food preparation via the personal digital assistance; and

FIG. 11 is a block diagram of the seat and user identification system; and

FIG. 12 is a depiction of the service request queue with pending transactions; and

FIG. 13 is a table diagram of the attendant id table; the attendant id table/table id, seat id xref table, and the seating location table.

FIG. 14 is a flow chart of the service queue updating process by the attendant.

FIG. 15 is a flow chart of the attendant allocation process for a service request.

### SUMMARY

An apparatus for electronic customer-attendant interaction in a food service establishment, said apparatus comprising: a computer server, said computer server comprising: a programmable central processing unit, a memory unit, a server wireless network interface, a peripheral interface; and wherein said processing unit is operatively connected to said memory unit; and wherein said processing unit is operatively connected to said server wireless network interface; and wherein said processing unit is operatively connected to said peripheral interface.

There are a plurality of personal computing devices; each personal computing device having a personal computing device wireless network interface; and a wireless network interface. The personal computing device wireless network interface are connected so that food service information is sent from the computer server to the personal computing devices and service requests are sent from the personal computing devices to the computer server.

Programs select the waiters and attendants for a particular customer who is seated at a particular location as identified by a unique table id and seat id. Customers can order meals from an electronic menu, make real-time requests from the attendant, and pay the final bill.

### DETAILED DESCRIPTION

The present invention provides a method, apparatus, and computer instructions for improving the interaction between customers and attendants in a restaurant, bar, or other food service establishment (herein to be referred generically as “a restaurant”), enabling a wireless computer-mediated communication to facilitate service requests from customers and other information exchanges between customers and attendants.

As used herein the words “attendant” is used to mean a person working in a restaurant that might interact with a customer such as a waiter, waitress, busboy, maître d', barmaid, cashier, kitchen staff, and/or other employee of a restaurant with whom a customer may choose to interact with and/or communicate with. Also included in the present embodiment are novel methods for processing situational facts such as the seat location of customers.

As used herein the words “user” is synonymous with the word “customer” as the person, or groups of people who are receiving the services of a particular resturant.

As used herein the words “menu” refers to the a list of food dishes and variations thereof that may be ordered in a restaurant. In some instances the order may be equivalent to the items printed on a traditional paper menu, or the customer may “order off the menu”, e.g. requesting a customized meal.

A wireless communication medium is provided local to a restaurant to allow a customer of the restaurant to communicate from a personal wireless computing device local to the customer to one or more other computers, the other computers associated with the restaurant. In a preferred embodiment, a “hot spot” location is provided for the restaurant, the hot spot providing the wireless communication with the personal wireless computing device used by the user.

Wireless Restaurant Infrastructure

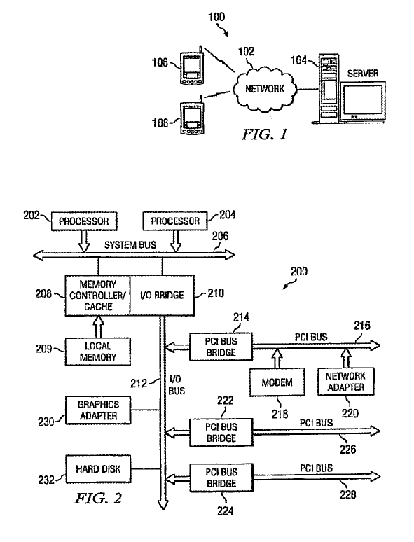

Now referring to FIG. 1. In FIG. 1 a network data processing system is depicted in which the unique features and functions of the preferred embodiment are implemented. Network data processing system 100 includes network 102, which is the medium used to provide communications links between various devices and computers connected together within network data processing system 100, a server 104, clients 106, 108.

In the preferred embodiment, the network data processing system 100 is the Internet with network 102 representing a world wide collection of networks and gateways that use the transmission control protocol/internet protocol (TCP/IP). Network data processing system 100 also may be implemented as a number of different types of networks, such as, for example, an intranet, a local area network (LAN), or a wide area network (WAN).

In the depicted example, server 104 is connected to network 102 and is a computer associated with a restaurant. Note, in the current context the word “server” refers to a computer server, not a restaurant employee as the word “server” is also used within this document.

Clients 106 and 108 are connected to network 102. In an implementation, clients are connected through wireless communications links and are wireless devices. In this example, clients 106 and 108 are personal digital assistants (PDA), although they could be other types of personal wireless computing devices such as a portable media players, a portable gaming systems, phones, and/or other similar devices. Such wireless computing devices may be handheld, body-worn, head-worn, or otherwise portably carried about by its user.

Server 104 in this example may provide data, such as boot files, operating system images, applications, web pages, and other information to clients 106 and 108. Network data processing system 100 may include additional servers, clients, and other devices not shown. For example, other devices may include routers, switches, or wireless access points to provide for the routing and transmission of data within network 102.

Within the network 102, wireless communication links may be provided through various wireless access points, the points often called “hot spot” locations. In this manner, clients 106 and 108 may access network 102 when they are within a hot spot location. In these examples, a hot spot location is a location in which a wireless device is in proximity to a wireless access point such that communication or exchange of data may be made with that wireless access point.

The preferred embodiment allows for the user of a client device 106, 108 to interact wirelessly with attendants of a restaurant. This interaction consists of receiving information from one or more computers associated with the restaurant and sending information to one or more computers associated with the restaurant. The information influences the actions of the attendants of the restaurant.

These interactions may be made through communications with the server 104, such as server 104. The attendants of the restaurant may receive information from the user and/or about the user from the server, either by accessing the server directly, by accessing a terminal connected to the server, and/or by using their own personal wireless computing device that also communicates with the server 104.

Now referring to FIG. 2. As shown in FIG. 2, a block diagram of a data processing system that may be implemented as a computer server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 106 and 108 in FIG. 1 may be provided through modem 218 and network adapter 220 connected to PCI local bus 216 through add-in connectors. Additional PCI bus bridges 222 and 224 provide interfaces for additional PCI local buses 226 and 228, from which additional modems or network adapters may be supported. In this manner, data processing system 200 allows connections to multiple network computers. A graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

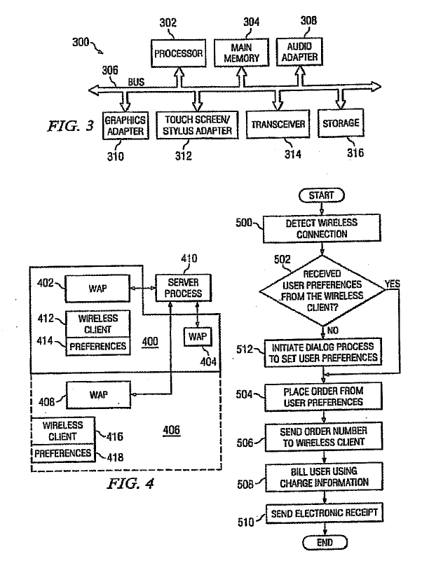

Turning now to FIG. 3. FIG. 3 depicts a diagram of a wireless device in the form of a personal digital assistant (“PDA”) 300 is shown in accordance with a preferred embodiment of the present invention. An example of the PDA 300, is the wireless client 106, 108, as shown in FIG. 1.

PDA 300 includes processor 302 and main memory 304 connected to system bus 306. Further, PDA 300 also includes audio adapter 308, graphics adapter 310, touch screen/stylus adapter 312, transceiver 314, and storage 316 connected to system bus 306. In some embodiments the PDA may include a Bluetooth communication adapter for networking and/or peripheral attachment. In some embodiments the PDA may include a digital camera, digital video camera, and/or GPS sensor. As mentioned above, the PDA may be replaced by other similar devices with similar components such as a portable music player, a portable gaming system, a wireless phone, a handheld GPS navigation system, and/or other portable computing device with wireless communication capability, information display capability, and a user interface to support user data entry.

Audio adapter 308 and graphics adapter 310 provide an interface for the user to hear and see information. The stylus 312 allows the user to interact with PDA 300. This particular component allows the user to use a stylus 312 to input data into a touch screen display on PDA 300. In some embodiments a microphone may be used for user data entry through spoken commands, the users voice processed by a speech recognition software system running upon the PDA or other similar personal computing device.

Processor 302 executes instructions stored in main memory 304 to provide the process and function of the present invention. Storage 316 provides for additional storage of data and applications. Storage 316 may take various forms, such as, for example, a flash memory. Transceiver 314 provides for sending and receiving data through a wireless communications link.

An operating system runs on processor 302 and is used to coordinate and provide for control of various components within PDA 300 in FIG. 3. The operating system may be, for example, a commercially available operating system, such as Windows Mobile, which is available from Microsoft Corporation. Instructions for the operating system and applications or programs are located on storage 316 in these examples. These instructions may be loaded into main memory 304 for execution by processor 302.

Those of ordinary skill in the art will appreciate that the hardware in FIG. 3 may vary depending on the implementation. Other internal hardware or peripheral devices, such as additional storage in the form of flash read only memory (ROM) or equivalent may be used in addition to or in place of the hardware illustrated in FIG. 3. Depending on the particular implementation, other types of wireless devices may be used. For example, a wireless digital phone, laptop computer, portable music player, portable gaming system, or a tablet computer may be used as a client.

User Interaction with the Wireless Restaurant Infrastructure

Turning next to FIG. 4, a diagram illustrating components used in enabling customer interaction with the attendants in a restaurant through wireless communication link is depicted in accordance with the preferred embodiment of the present invention. In this example, hot spot location 400 is provided through wireless access point (WAP) 402 and wireless access point 404. In this illustrative example, hot spot location 400 is the interior of a restaurant. Another hot spot location, hot spot location 406 is provided outside of the restaurant through wireless access point 408. For example, hot spot location 406 may be provided for patio dining for the restaurant. These wireless access points are in communication with server process 410. Server process 410 may be executing on a server, such as data processing system 200 in FIG. 2. This server process may be located on the premises of the restaurant or in a remote location, depending on the specific implementation.

In this example, wireless client 412 is the to be within hot spot location 400 when client 412 is able to establish a communications link with wireless access point 402 or wireless access point 404, which form hot spot location 400 in these examples. In this manner, wireless client 412 is able to exchange data with server process 410, resulting in the exchange of information.

Part of this information includes for example, a table identification value and/or seat identification value corresponding to the user's then current location within the restaurant, the table identification value and/or seat identification value sent from the wireless client 412 to the server process 410.

Part of this information includes for example, menu information sent from the server process 410 to the wireless client 412, the menu information optionally including and/or reflecting then current updates such as daily specials and/or dish availability restrictions and/or market price fluctuations, the menu information optionally also including caloric information for various menu selections and/or fat information for various menu selections and/or other nutritional information associated with various menu selections, the menu information optionally also including subjective rating information for various menu selections, the subjective rating information having been entered in whole or in part by other previous customers to the restaurant. The menu information includes for example, food and drink options available to be ordered from the restaurant, the food and drink options including preparation characteristic options and/or service characteristic options for one or more of the selections. This information also includes food and drink selections being sent from the wireless client 412 to the server process 410, the food and drink selections including preparation characteristic selections and/or service characteristic selections for one or more of the food and drink item selections. This information may also include a drink refill request sent from the wireless client 412 to the server process 410.

This information may also include a bill request sent from the wireless client 412 to the server process 410 to. This information may also include a dish clearing request being sent from the wireless client 412 to the server process 410. This information may also include a request that a next course be served to the user at the current location within the restaurant, the request being sent from the wireless client 412 to the server process 410. This information may also include a request that payment be collected and change delivered to the user at the current location within the restaurant, the request being sent from the wireless client 412 to the server process 410.

This information may also include a preparation status update for one or more items within the order placed by the user, the preparation status update being sent from the server process 410 to the wireless client 412. This information may also include a visual camera view of the kitchen of the restaurant represented as a digital image file and transferred from the server process 410 to the wireless client 412, the visual camera view being displayed to the user by the wireless client, the visual camera view being updated over time. In some embodiments the visual camera view is a digital video file.

This information may also include an updated bill for the user based upon the user's then current order, the updated bill being sent from the server process 410 to the wireless client 412. This information may also include user identifying information such as the user's name and/or credit card information and/or billing address and/or personal food preferences and/or food nutrition preferences and/or an indication of personal service preferences and/or an indication of personal food preparation preferences.

The user identifying information is referred to herein as User Info and may be stored in advance within the wireless client 412 prior to entering the restaurant. In this way, information that may always be the same for the user need not be repeatedly entered by the user. The information, including the User Info, is referred to herein as User Data and is labeled as 414 in the figure, the User Data being located within wireless client 412.

In some embodiments, also stored within the User Data is a historic tally of caloric information and/or fat information and/or other nutrition information associated with previously ordered and consumed food items as received from a server process through the methods disclosed herein. In this way a user can keep track of his or her nutritional consumption at restaurant in an automated manner.

Wireless client 416 is in hot spot location 406 in this example. In a similar manner, wireless client 416 is able to exchange data with server process 410, the data representing similar information as that described in the paragraph above. In these examples, the data includes User Data 418 stored within wireless client 416. In these examples, wireless clients 412 and 416 are PDAs, such as PDA 300 in FIG. 3.

When a user places an order through wireless client 412 or wireless client 416 this order is processed through server process 410. In this illustrative example, a user with wireless client 412 places an order from a table within the restaurant in hot spot location 400. Another user with wireless client 416 places an order from a patio table outside of the restaurant in hot spot location 406. An important aspect of the present invention is the communication of a seating location from the wireless client 412 to the server process 410 such that the server process 410 can indicate to one or more attendants within the restaurant where to go to service the user. Without this information the restaurant attendants would not have a convenient and efficient way to deliver food and/or deliver checks and/or bring change and/or give drink refills and/or clear dishes and/or perform other functions in response to the wireless interaction between the user and the attendants as moderated by the server process 410.

To support this preferred embodiment, a table identification value and/or seat identification value that corresponds with the user's then current seating location within the restaurant is sent from the wireless client 412 to the server process 410. In a preferred embodiment this value (or values) is sent upon the user taking a seat within the restaurant and is stored within memory accessible to the server process 410 during the duration of the users meal, the value (or values) being associated in memory with a unique ID corresponding to the particular wireless client device used by the user. In this way the server process keeps track of the seating location that corresponds with each wireless client device being used by a user within the restaurant and/or within the outdoor seating of the restaurant. This data stored in memory is thereby used by server process 410 to give an indication to the attendants of the restaurant which table and/or seat each food and/or drink order should be delivered and/or which table and/or seat each refill request has come from and/or which table and/or seat each dish clearing request has come from and/or which table and/or seat each next course request has come from and/or which table and/or seat each bill request and/or change request and/or other service request has come from.

Menu Initialization

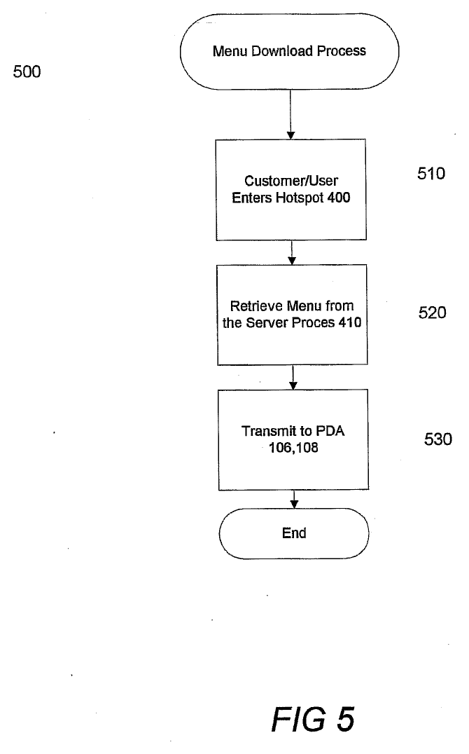

Now referring to FIG. 5. As shown a FIG. 5 a menu initialization process 500 is shown. A PDA 106,108 detects the wireless device 400 within the hot spot location 510, a menu for the restaurant is sent to the wireless device for use in placing an order 520. The menu optionally updated 550 for the then current daily specials 540 and/or the then current availability 530 of dishes. In this way a waiter does not need to deliver a menu to the user and/or present daily specials to the user and/or comment on any dishes that may or may not be then currently available. Similarly the customer does not need to wait for a menu to be delivered to him by the waiter, does not need to wait for daily specials to be recited to him or her, and/or will less likely be surprised at a later time by ordering a dish only to find out that the restaurant is out of that dish. In addition any dishes that have varying prices, such as certain sea food that may fluctuation with market prices, will optionally have their then current prices indicated upon the wirelessly downloaded menu. In this way a user can read the prices of the dishes from the downloaded menu and does not need to inquire as is typical with printed menus.

Food Selection

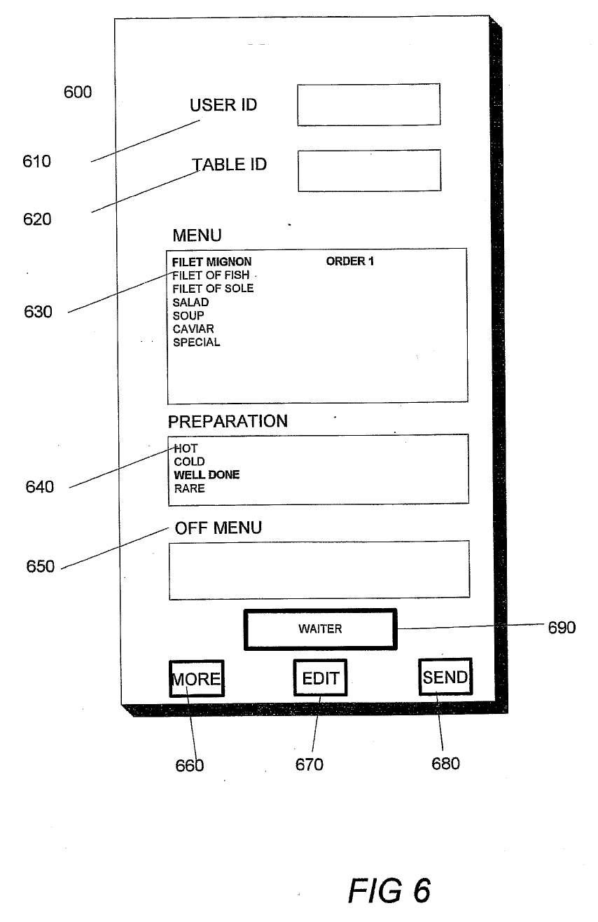

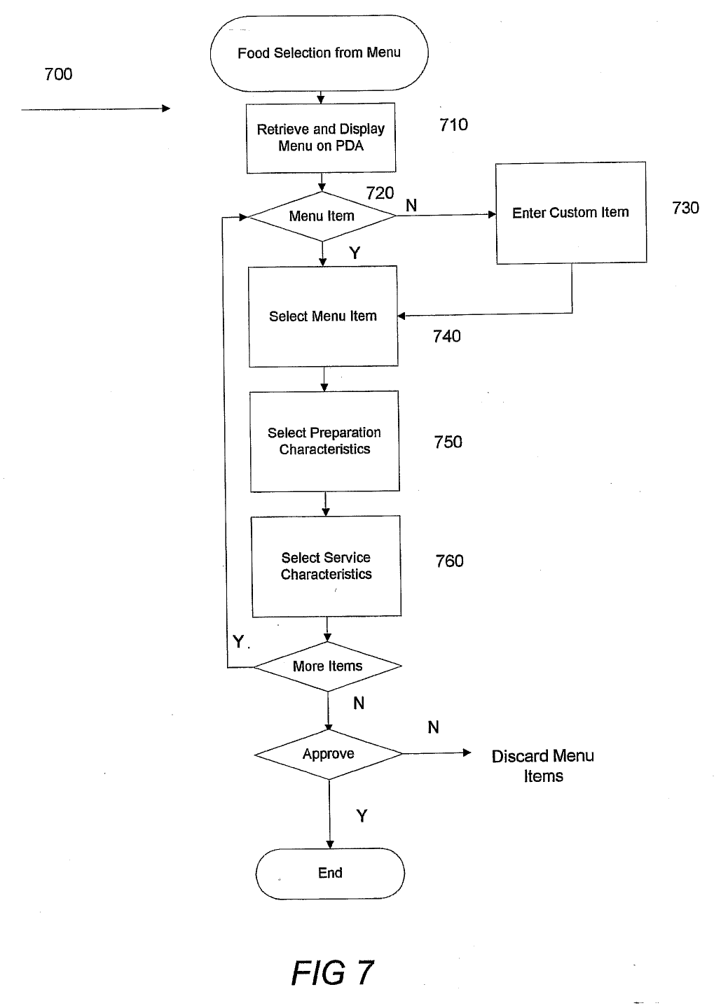

Now referring to FIG. 6 and FIG. 7. In FIG. 6 a pictoral representation of the menu is shown on the PDA 106. On the PDA 106 is programmable display 600, with a user text field 610, a table and seat identifier pair 620, and a list of menu items 630, a method of preparation 640, and a field to enter text 650 for “off menu” selections. The programmable display 600 refreshes with each menu selection by pressing the “MORE” key 660. The menu selections may be edited with the “EDIT” key 670. When the final meal has been selected then the SEND 680 button may be selected to send the requested menu choices to the server. A “waiter” button 690 is selected to request live service from a waiter.

Now referring to FIG. 7. In FIG. 7 a flowchart 700 is shown of the menu selection process on the PDA 106. Once the menu has been downloaded and displayed to the user upon the wireless computing device 106, the user may make selections through a user interface displayed to the user upon the PDA 106. One of the selections may include requesting live service from a waiter or other server via a button 690 on the PDA 106. This is the case where customer may have questions and/or may want direct personal service. Other of the selections allow the user to choose the food items 740 that he or she wants to order. The selections are referred to herein as food selections, the food selections including not just food but drinks and deserts as well. The selections allow for dishes to be identified as well as customized 730, indicating for example how dishes should be prepared (i.e. rare, medium rare, well done) 750 and/or what kind of dressing the user desires (i.e. ranch, thousand island, blue cheese). The characteristics that indicate how food items should be prepared as referred to herein as preparation characteristics. Similarly the selections allow the user to indicate drink items that he or she wishes to receive.

In addition, the selections allow the user to indicate how the courses of a meal should be served if ordering a multi-course meal, indicating, for example, if he or she wants the dishes to come out (a) as soon as possible, (b) only after a previous course has been finished, (c) in whatever order they are prepared, and/or allows the user to indicate any special requests about service speed, such as to indicate if the user is in a rush. The characteristics relating to how the courses of a meal should be served are referred to herein as service characteristics 760. Once the information has been entered by the user into the PDA 106, the user is given an opportunity to review his or her selections and approve. Once approved, the order, including the indication of which dishes, preparation characteristics, and service characteristics, is sent from the personal wireless computing device to one or more computers associated with the restaurant over the wireless link.

Billing

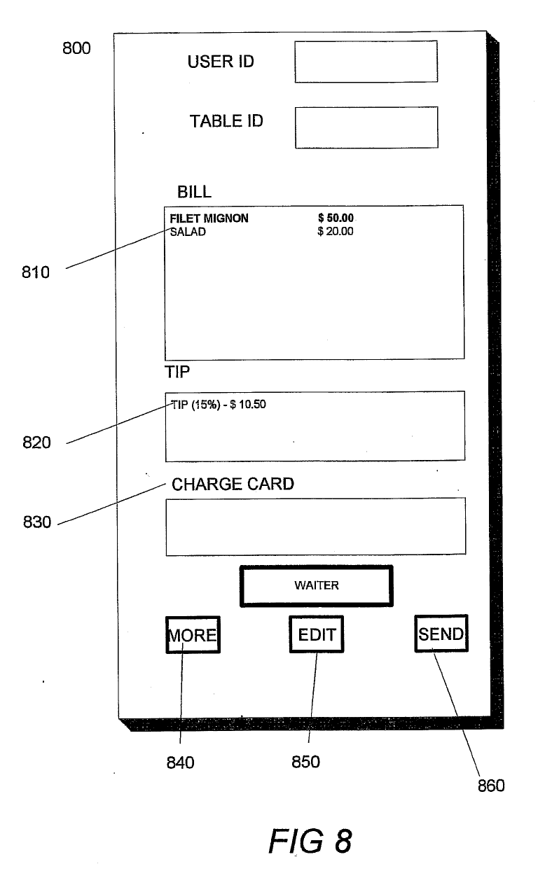

Now referring to FIG. 8. As shown in FIG. 8, a representation of the bill as displayed on the screen is shown. The restaurant computer 104 transmits the bill to the PDA 106 upon a user request. If the user orders additional items later in the meal, the bill is updated in real time, providing improved tracking of expenditures to customers over traditional ordering methods. The bill provides for a listing of items ordered 810, a field for the calculated tip 820, and a field where the person may enter their credit card information. The user may also scroll through the list of charges using the button 840, edit the charges with button 850, and then approve the charges with button 860.

Table and Seat Identification

In addition to indicating the food items the user desires to order from the restaurant and indicating the course service characteristics of how the dishes should be served, the present invention allows the personal wireless device to indicate to the restaurant computer over the wireless link an indication of which table the user is sitting at. In some embodiments the present invention also allows the personal wireless computing device to indicate to the restaurant computer over the wireless link an indication of which seat at the table the user is sitting at. The indication of which table a user is sitting at is referred to herein as a table identification value. The indication of which seat a user is sitting at is referred to herein as a seat identification value.

Service Requests

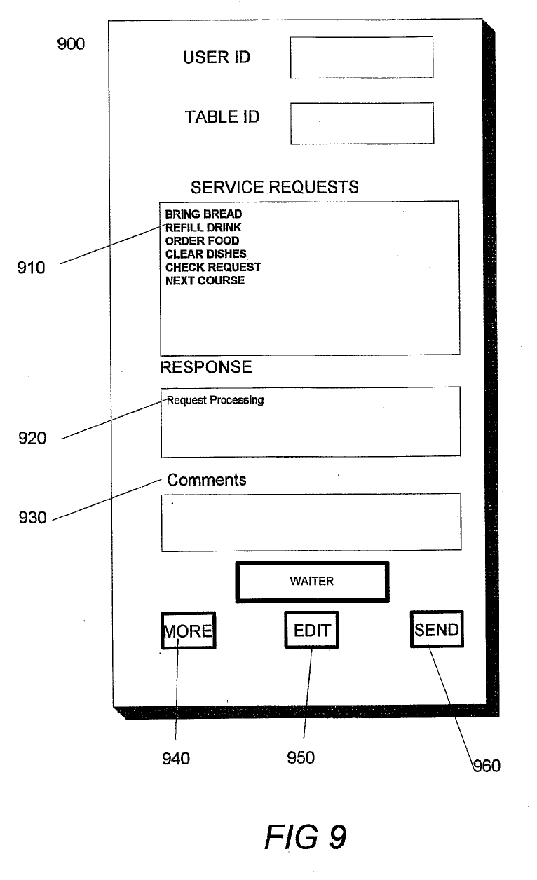

Now referring to FIG. 9. In FIG. 9 a representation is shown of the PDA 106 with a screen 900 of the service request menu on the PDA. As shown a service request field 910 is shown in which the user may provide real-time requests to the restaurant computer indicating his or her current needs, the restaurant computer routing the service requests to one or more attendants.

For example, as enabled by the current invention the user may use his or her wireless personal computing device to send a refill request to the restaurant computer, the refill request indicating that one or more drinks of the user, or of the user's table, is in need of a refill by a server. The refill request may indicate which drink requires a refill and/or may indicate which seat at the user's table requires a refill. Similarly, as enabled by the current invention the user may use his or her wireless personal computing device to send a bread request to the restaurant computer, the bread request indicating that more bread is needed to be brought to the table by a server.

Similarly, as enabled by the current invention the user may send a check request to the restaurant computer, the check request indicating that the user, or the table of the user, would like to have a bill sent to the table. Such a request is useful if the user desires to pay with cash. If the user would prefer to pay by digital means, such as a credit card, the user could simply pay through the wireless portable computing device and can avoid this step of requesting a physical check. Once the user puts cash on the table and is ready for change, he or she may then send a change request to the restaurant computer, the change request indicating that the user, or the table of the user, has put down his or her cash and would like to complete the cash payment and get change delivered back to the table. Similarly, as enabled by the current invention the user may send a next course request to the restaurant computer, the next course request indicating that the user, or the table of the user, would like a server to bring the next course in a multi-course meal to the table. The next course request, in some embodiments of the present invention, can include an urgency level that indicates how urgent the need for a next course is. In this way a user who is in a rush can indicate that speed is required in the requested service. Similarly, as enabled by the current invention the user may send a dish clearing request to the restaurant computer, the dish clearing request indicating that the user, or the table of the user, would like a server to visit the table as soon as possible and clear one or more dishes from the table. The dish clearing request, in some embodiments of the present invention, can include an urgency level that indicates how urgent the need for dish clearing is. Similarly, as enabled by the current invention the user may send a general service request to the restaurant computer, the check request indicating that the user, or the table of the user, would like a server to visit the table as soon as possible. The service request, in some embodiments of the present invention, can include an urgency level that indicates how urgent the need for a server visit is. In this way a user can have a server visit the table for any general reason, such as to bring new silverware, to get more napkins, or to answer a question.

The PDA 106 also has a response field from a service request 920 indicating the field is processing. Likewise, comments from the attendant may be displayed in a field when sent from the computer in the field in a status field 930.

Alternately, the user request on the service request screen 920 the status of various menu items that have been selected. For example, the user may request a preparation status update on a meal that is then currently being prepared, the status update indicating either (a) an estimated time of delivery or time delay until delivery, and/or (b) an indicating of where the food item is listed in a queue of pending food items to be prepared. In this way the user can find out the status of an order without needing to wait for a waiter to take such a request and then check on the request and then return with a status update. In many cases such status information can placate an impatient customer by simply providing insight into the preparation process rather than assuming he or she has been forgotten or assuming that his or her order is being ignored.

Wireless Kitchen Camera Link

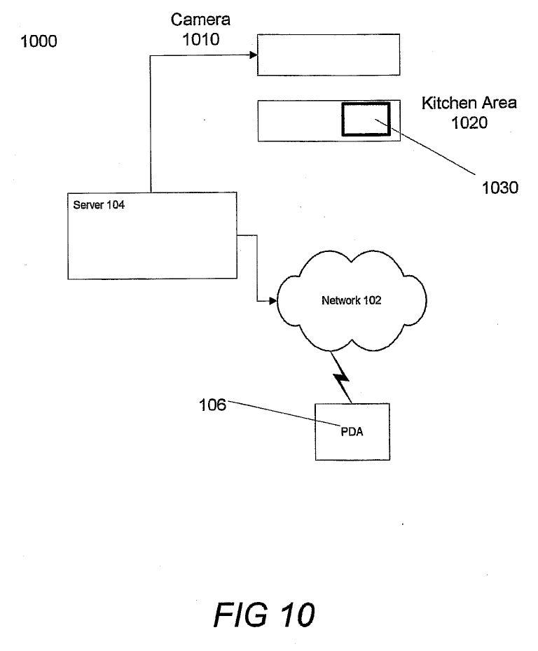

Now referring to FIG. 10. In FIG. 10, a system diagram 1000 is shown that supports the status inquiry function previously described. The can indicate on his or her personal wireless computing device 106 that he would like to see the action in the kitchen. By selecting the option, the personal wireless communication device is sent data from one or more cameras 1010 mounted in the kitchen of the restaurant. The cameras, which are preferably digital video cameras, provide the user with a live images of the kitchen action and food preparation 1020. This feature is referred to herein as an optional wireless kitchen camera link and may allow the user to select between a pluralities of different cameras to achieve different views of the kitchen area. In an embodiment 1030 the user is notified by receiving a signal on his or her personal wireless computing device that his or her food item is then currently being prepared. The indication may then query the user, asking if the user would like to view the wireless kitchen camera link and thereby view his or her food item being prepared. In some cases there may be multiple camera on multiple stoves thus the indication sent to the personal wireless computing device 106 has a smart tracking feature that tracks which kitchen area to display to the user when his or her food item is being prepared. In this way a user can have a personalized experience, viewing his or her own food being prepared by looking at the screen of his or her wireless portable computing device. This feature is referred to herein as personalized food preparation viewing and is enabled through the wireless kitchen camera link.

As previously described the user has the ability within a restaurant to use a portable computing device 106 to: (a) indicate a table identification value and/or seat identification value corresponding to his or her then current location within the restaurant; (b) have a menu of available food and drink items be transferred as a digital file to the user's portable computing device and be displayed to the user, the menu including and/or reflecting then current updates such as daily specials and/or dish availability restrictions and/or market price fluctuations; (c) place an order of specific food and drink selections from the menu of the restaurant, the order including preparation characteristics and/or service characteristics for one or more selections, the order to be delivered to the user at the current location within the restaurant as indicated by the table identification value and/or seat identification value by one or more attendants of the restaurant; (d) request a drink refill be delivered to his or her then current location within the restaurant by an attendant of the restaurant, (e) request that a bill be delivered to the current location within the restaurant by an attendant of the restaurant; (f) request that dishes be cleared from the current location within the restaurant by an attendant of the restaurant; (g) request that a next course be served to the current location within the restaurant by an attendant of the restaurant; (h) request that payment be collected and change delivered to the current location within the restaurant by an attendant of the restaurant; (i) have a preparation status update for one or more items within to placed order be transferred as a digital file to the user's portable computing device and be displayed to the user; (j) have a visual camera view of the kitchen of the restaurant be transferred as a digital file to the user's portable computing device and be displayed to the user; (k) have a visual camera view of one or more items within the user's placed order being prepared within the kitchen of the restaurant be transferred as a digital file to the user's portable computing device and be displayed to the user; (l) have an updated bill be transferred as digital file to the user's portable computing device and be displayed to the user, are collectively given as examples of how the invention enables wireless valuable and time saving customer interaction with the attendants working in a restaurant.

Entering Table Identification Values and/or Seat Identification Values:

To support this inventive method of using and storing table identification values and/or seat identification values that correspond with each user's then current seating location within the restaurant in memory accessible to the server process 410 and associating the values in the memory with a unique ID corresponding to each particular wireless client device used by each user at each of the current seating locations, a number of inventive method of entering the table identification values and/or seat identification values has been developed.

In one method the user of a particular wireless client device enters a restaurant and takes a seat and is queried by the user interface that is displayed upon his or her wireless client device for a table identification value and/or seat identification value. In some embodiments the values are inscribed upon the physical table and/or physical seats of the restaurant. In such embodiments the user looks at the physical table and/or seat at which he or she has sat himself at and enters the displayed value into the user interface of his or her wireless client device. For example, the table that the user sits down at may have an identification number written on the upper surface at the edge in a visible location. That number may be, for example, “14” for the particular table a particular user sits. All other tables within the restaurant would have a different and unique identification number inscribed upon it. Also, each seating location around the table may have a unique identification value inscribed upon it. In this particular example the user has sat himself at a table with four seats, each of the seats being labeled with a unique identifying letter “A”, “B”, “C” and “D”. The user in the present example sits himself at location “B” of the table. In this way every location that the user may have sat at within the restaurant is identified by a unique table number and seat letter. In other embodiments only numbers are used for both tables and seats.

In other embodiments only letters are used for both tables and seats. In other embodiments other identifiers are used. In this particular example, the user follows the method of the present invention and enters the unique table identifying number for his particular table and the unique seat identifying letter for his particular seat into his wireless client device. The unique table identifying number and unique seat identifying letter is sent as unique table and seat identifying data from the wireless client device to the server process, the server process associating the data with a unique ID corresponding with that particular wireless client device. In this way the server process 410 can indicate to attendants which table and seat to go to service this particular customer of the restaurant.

While the above example uses both a unique table identifier and a unique seat identifier, some embodiments only use a unique seat identifier. For example, every seat within the restaurant may be assigned a different unique value, the value being inscribed upon the seat or upon the table in a location associated with the seat. In such embodiments the user only needs to enter a single identifier, not the pair as described in the example above.

Automated Table Location and/or Seat Location Identification Methods

Other inventive methods have been developed for allowing a user to enter a unique identifier that indicates the particular table and/or seat a user is sitting at when communicating with the server process through the wireless client device.

To eliminate the step of manually entering a table value and/or seat value into the wireless client device, an automated method has been developed that allows the user to more quickly and easily enter the unique table identifying value and/or unique seat identifying value into his or her wireless client device, the automated method using a sensor on board the wireless client device to automatically detect the unique table identifying value and/or seat identifying value.

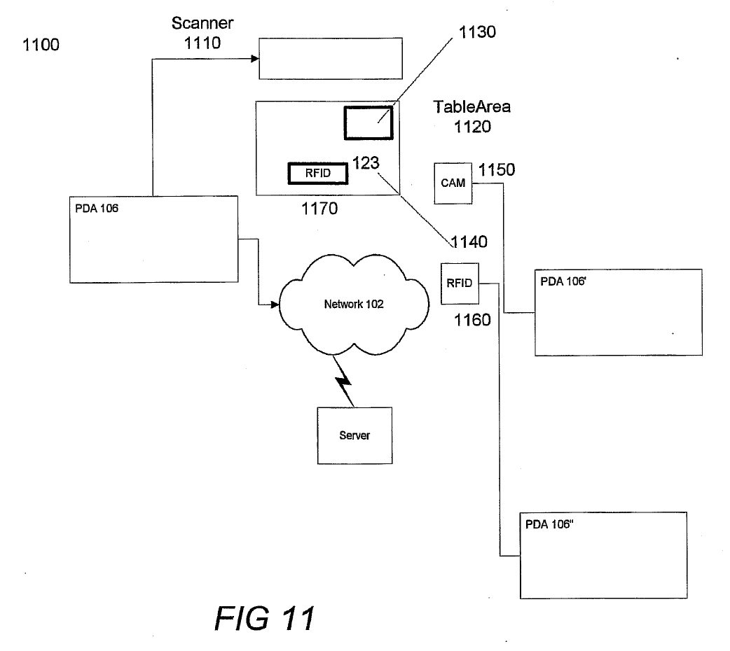

Now Referring to FIG. 11. In one embodiment the sensor is a bar-code scanner 1110 attached to and/or incorporated within the wireless client device 106. In such embodiments the table identification value and/or the seat identification value is encoded as a barcode 1130 that is printed upon or otherwise affixed to the table and/or the seat within the restaurant. For example, in one embodiment a unique barcode 1130 sticker is affixed to each unique seating location of each table 1120 within the restaurant, each of the barcode stickers 1130 being affixed at a location near the unique seating location around the table, each of the barcode stickers being encoded with a unique table identification value and/or seat identification value. In this way a user who sits down at the table 1120 scans the barcode sticker 1130 that is nearest to his or her seating location at the table 1120, the user performing the scan of the barcode sticker with the barcode scanner attached to and/or incorporated within the wireless client device. In this embodiment each unique barcode sticker encodes a particular table 1120 identification value and/or seat identification value such that when it is scanned, the particular table identification value and/or seat identification value is accessed by the wireless client device. In this way, by scanning the barcode 1130 associated with the user's particular table and/or seat, the user's wireless client device accesses and stores in memory values that indicate his or her seating location within the restaurant. The wireless client device communicates the values to the server process as part of the inventive methods disclosed herein, the values being used by the server process to communicate to attendants of the restaurant what services are required of particular seating locations within the restaurant. In some embodiments that use barcodes, a variety of barcode methods may be used. For example in an alternate embodiment a single barcode sticker is affixed to a table, the barcode sticker encoding a unique table identification value and a different user interaction method is used to enter which seat at the table the user is sitting at (for example by entering a letter “A”, “B”, “C”, or “D” into the user interface of the wireless client as described above).

In another embodiment the sensor is a digital camera 1150 that employs optical image recognition software to determine the table identification value and/or seat identification values associated with a user's seating location within the restaurant. In such an embodiment multiple unique graphic and/or text representations is affixed to and/or inscribed upon the table 1120, each of the unique graphic and/or text representations being located at or near a particular seating location around the table. Each of the unique graphic and/or text representations 1140 encodes a particular table identification value and/or seat identification value such that when it is captured by the digital camera and processed with the image recognition software, the particular table identification value and/or seat identification value is accessed by the wireless client device. In this way, by capturing with the digital camera 1150 the unique graphic and/or text representation 1140 associated with the user's particular table and/or seat, the user's wireless client device accesses and stores in memory values that indicate his or her seating location within the restaurant. The wireless client device 108 communicates the values to the server process as part of the inventive methods disclosed herein, the values being used by the server process to communicate to attendants of the restaurant what services are required of particular seating locations within the restaurant.

In another embodiment the sensor is an RF ID scanner 1160 that is connected to or incorporated within the wireless client device such that the RF ID scanner 1160 can access and read data from an RF ID tag 1170 when it comes within a certain proximity of the RF ID tag 1170. In such an embodiment RF ID tags are affixed to or embedded within or attached to locations local to a plurality of tables 1120 and/or seating locations within the restaurant. For example in one embodiment a unique RF ID tag 1170 is affixed to each seating location of each table within the restaurant, each of the unique RF ID tags being encoded with a unique table identification value and/or seat identification value for the seating location of the restaurant. In such embodiments, the RF ID tags 1170 are used that are configured to have a small distance range of operation such that when the user is sitting at a particular table within the restaurant and/or is sitting at a particular seating location at a particular table within the restaurant, the RF ID scanner only accesses a particular one of the multiple RF ID tags 1170. In this way, by scanning the RF ID tag associated with the user's particular table and/or seat, the user's wireless client device accesses and stores in memory values that indicate his or her seating location within the restaurant.

The wireless client device 106″ communicates the values to the server process as part of the inventive methods disclosed herein, the values being used by the server process to communicate to attendants of the restaurant what services are required of particular seating locations within the restaurant. In some embodiments that employ RF ID tags 1170, a variety of barcode methods may be used. For example in an alternate embodiment a single RF ID tag 1170 is affixed to a table, the RF ID tag encoding a table identification value and a different user interaction method is used to identify which seat at the table the user is sitting at (for example by entering a letter “A”, “B”, “C”, or “D” into the user interface of the wireless client as described above).

Other sensors may be attached to and/or incorporated within the wireless client and configured to detect a unique table identifying mark or signal and/or a unique seat identifying mark or signal when the user is seating a particular seating location within the restaurant thereby indicating to the wireless client which unique seating location the user is at. In this way, the present invention enables the user's wireless client device 412 to automatically access and store in memory values that indicate his or her seating location within the restaurant and communicate the values to the server process 410, the values being used by the server process to indicate to attendants of the restaurant what services are associated with and/or required for particular seating locations within the restaurant. For example, if a drink refill request is made by a user of a particular wireless client device, the drink refill request is communicated to an attendant of the restaurant by the server process. In some embodiments the refill request is communicated by a message that appears upon the screen of the computer running the server process, the screen being located in a place that is visible to attendants of the restaurant. In other embodiments the refill request is communicated to an attendant of the restaurant by a message that appears upon a screen of a different computer, the different computer being in communication with the computer running the server process. In some embodiments the different computer is a portable computer that is local to the attendant, for example a PDA held on the person of the attendant. In this way, the user makes a refill request using his wireless client device 412 by using the user interface upon the wireless client device, the refill request is communicated as a wireless signal to the server, the server process running code that processes the refill request, the server process accessing and using the unique table identifying value and/or unique seat identifying value to determine which unique seating location the refill request is associated with and to cause a message to be displayed to an attendant indicating that a refill request has been made from the unique table and/or seat location, the message being displayed for example upon a wireless PDA local to the attendant, the message being displayed in response to a wireless signal sent to the wireless PDA local to the attendant.

Service Request Routing

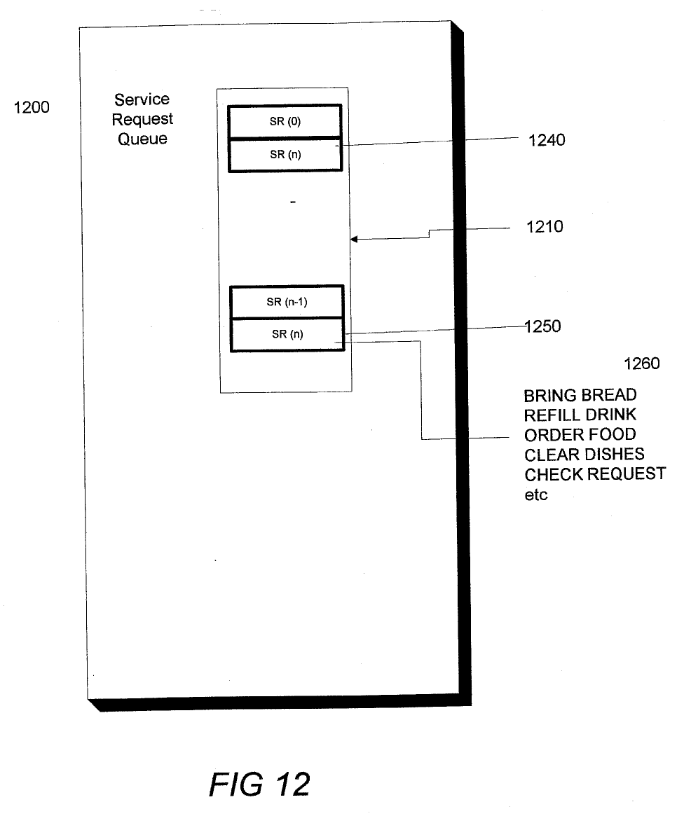

Now referring to FIG. 12. In FIG. 12 a pictorial depiction of the service request queue is shown. A service request queue is a software process implemented on the restaurant computer 104. In many embodiments of the present invention, a plurality of attendants are employed to service the customers of a given restaurant, the plurality of attendants each being assigned a particular set of tables that he or she is responsible. In such situations, when a service request 1260 is made by a user through his or her wireless client device 412, the user sitting a particular seating location with the restaurant, the server process 410 performs a method of routing the service request 1260 from the wireless client associated with the particular seating location to a particular attendant (or attendants) who has been assigned a set of tables that include the particular seating location.

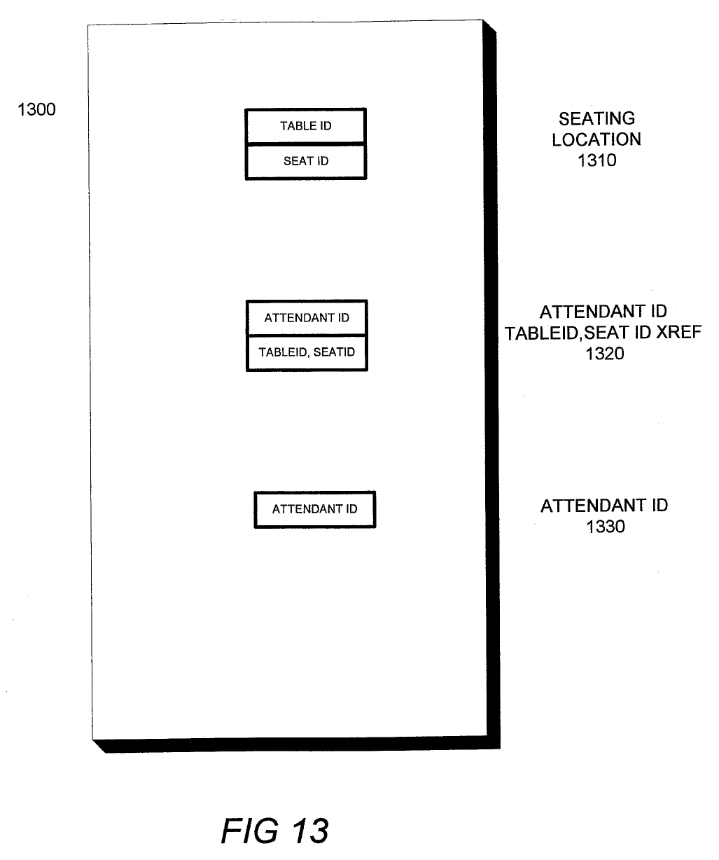

Now referring to FIG. 13. In FIG. 13 data structures are implemented to perform such a method, the server process maintains in accessible memory a listing of available attendants at a given point in time during the operation of the restaurant and a set of correlations that indicate which table locations and/or seating locations each of the available attendants are assigned. In some embodiments this is performed by assigning each attendant a unique Attendant ID 1330 and associating in memory each unique Attendant ID 1330 with a particular set of table identifying values and/or seat identifying values for which the attendant is responsible at a given point in time. This listing, referred to herein as the Attendant ID Seating Correlation Data, 1320 is maintained in memory accessible to the server process. Multiple Attendant ID values may be associated with the same table identifying values and/or seat identifying values within the Attendant ID Seating Correlation Data.

Following the embodiment disclosed herein, when a service request is made by a wireless client 412 that is being used by a user who is sitting at a particular seating location within the restaurant, the service request for example being a drink refill request, the server process 410 accesses the listing of correlation that associate Attendant ID values with table identification values and/or seating identification values (as represented within the Attendant ID Seating Correlation Data). Using the listing of correlations, the server process determines which Attendant ID (or Attendant IDs) is correlated with the particular seating location within the restaurant as determined by the table identification values and/or seating identification values sent by and/or associated with the wireless client 410. This Attendant ID (or Attendant IDs) is thereby determined to be a Responding Attendant for this particular service request. The server process then routes the drink refill request to that Responding Attendant. In this way the server process is operative to route service requests to a particular attendant (or attendants) who are associated with the particular seating location within the restaurant from which the service request was made (as indicated by the unique table identification value and/or seating identification value associated with the user who made the service request). In the present context the process of “routing” a service request to an attendant refers to displaying a message upon a computer screen or other user interface device that is likely to be received by the attendant, the message indicating what service is required or which particular seating location. In this example the message would indicate that a drink refill request was made and would indicate which table location and/or seating location the request was associated. It may also indicate what specific type of drink the request relates to, for example Coke, Iced Tea, or Diet Pepsi. When multiple requests are made from the same table, for example three different drink refill requests arrive from the same table location, each of a different seating location at the tabled, some embodiments of the present invention link the requests together such that they are displayed to the attendant in a message that is grouped. In this way the attendant knows that three drink refill requests need to be serviced at the particular table.

Service Request Management

Now referring back to FIG. 12. The server process maintains in memory accessible to the server process a listing of pending service requests that have been received as well as an indication of which attendant (or attendants) each of the service requests have been routed to (as indexed by their unique Attendant ID). In this way the server process maintains a stored queue of all outstanding service requests that must be serviced by each of the attendants.

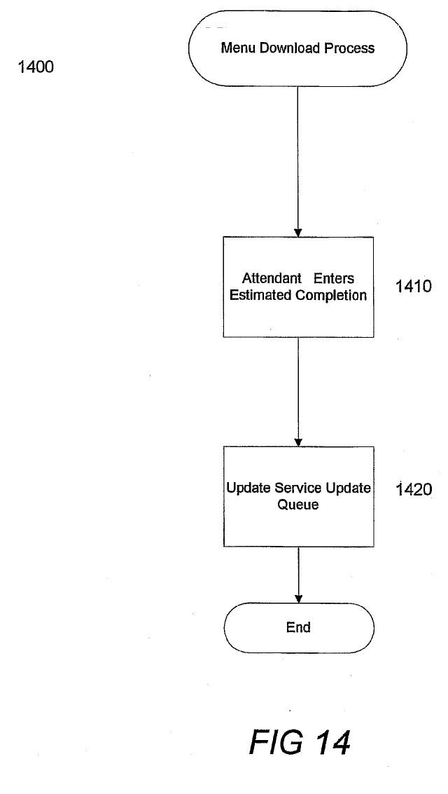

Now referring to FIG. 14 a flowchart 1400 is shown for the processing of the Pending Service Request Queue. The service request as stored in the queue includes a set of relevant data, including the time the request came in, the type of service request, the seating location and/or table location from which the request was made, the details of the request, the Attendant to whom the request was assigned, and the current status of the request. When an attendant completes a particular service request, the attendant sends data to the server process to indicate its completion 1410. In some embodiments this is achieved by the attendant interacting with a keyboard (or other user interface device) connected directly to the server. In some embodiments this is achieved by the attendant interacting with a keyboard (or other user interface device) connected to a terminal that is connected to the server. In some embodiments this is achieved by the attendant interacting with the keyboard (or other user interface device) of a wireless device local to the attendant, the wireless device local to the attendant in wireless communication with the server process. Whichever way it is done, the attendant interacts through a direct, wired, or wireless connection with the server process, indicating that a service request has been completed. When a service request has been completed, the server process updates 1420 the Pending Service Request Queue in the memory accessible to the server process, either eliminating the service request from the queue once it has been completed and/or updating the status of the request to indicate that it has been completed. Service requests that have not been updated have the status updated for future query operations.

Intelligent Service Request Routing

In some embodiments wherein multiple Attendants share responsibility for some or all of the same table locations or seating locations within the restaurant, there may be multiple attendants that are determined by the server process to be correlated with a particular seating location from which a service request was received. In some embodiments, as described above, the service request is routed by the server process to all of the multiple Attendants that share responsibility. In the preferred embodiment, the service request is routed to only one of the multiple Attendants—the one attendant being selected from the multiple attendants using a method.

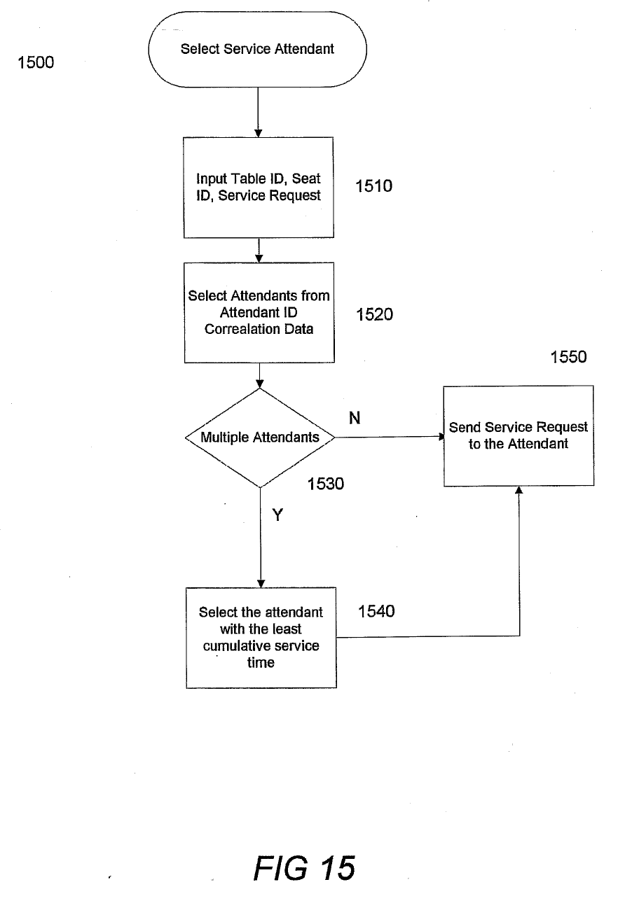

Now referring to FIG. 15 which depicts a flowchart 1500 of the process of selecting the attendant from a list of attendants.

When a new service request is received, 1510 the server process accesses the Attendant ID Seating Correlation Data 1520 to determine which attendant (or attendants) are responsible for the particular table location and/or seating location that is associated with the wireless client from which the request was made. If more than one of attendants 1530 are identified, then the server process selects one of the plurality of attendants by accessing the Pending Service Request Queue and determining which the plurality of attendants has the fewest pending service requests at the current time 1540. That one attendant whom has the fewest pending service requests (ie service requests that have not yet been completed), is assigned the new service request 1550. The Pending Service Request Queue is then updated and the service request is routed to that one attendant. In computing which of the plurality of attendants has the fewest pending service requests, a simple talley of the number of service requests may be made. In more advanced embodiments, some types of service requests that are known to take more time to complete may be weighted higher in the tally than other types of service requests that are known to take less time to complete. Some service requests that cannot be completed at a given point in time because of some other pending event, such as the completion of a dish being cooked, may be weighted less in the tally and/or not included in the tally at all. In this way the server process routes a new incoming service request to one of the plurality of attendants based upon a determination of which of the attendants is likely to have the smallest pending workload. By performing the preferred embodiment which consists of this method, the system disclosed herein will efficiently distribute incoming service requests among the available attendant staff.

Operational Example

A specific example of a preferred embodiment is presented. A user enters a restaurant with his 7 year old daughter and takes an available seat at an available table, his daughter taking the seat next to him. He takes out a wireless PDA from his pocket and turns it on. The wireless PDA links with a wireless hotspot within the restaurant, the PDA becoming a wireless client of the server of the restaurant. The wireless client performs a software routine, exchanging initial information with the server, downloading updated menu information, the updated menu information including the daily specials for the restaurant and any current availability limitations for the current menu. In addition, the wireless client presents a prompt to the user on the display of the PDA, the prompt asking the user to enter in his unique Table Identification value. The user looks at his table and notes an inscribed value at the head of the table that reads: T17. The user enters in this value into his PDA using the user interface, which in this case is a pen based stylus interface. The PDA stores this Table Identification value (T17) in memory and presents another prompt to the user on the display, the prompt asking the user to enter his unique Seat Identification value.

Again he looks at his table and notices an inscribed value directly in front of his seating location, the inscribed value reads: B. The user enters this value into his PDA using the user interface. The PDA stores this Seating Identification value (B) in memory and presents another prompt to the user on the display, the prompt asking the user if there are any other persons in his party that will be sharing this PDA interface for this meal. The user responds YES by interacting with the user interface on the PDA. The user then selects his daughter's name from a menu of common dining companions that is already stored within his PDA. The PDA then prompts the user for a seating location for his daughter. He looks at the table and notices an inscribed value directly in front of her seating location, the inscribed value reads: C. The user enters this value into his PDA using the user interface. The PDA stores this Seating Identification value (C) in memory and associates this value with his daughter. In this way the PDA has stored in memory a table identification value/seating identification value for both the user and for his daughter as follows: (T17, B) and (T17, C). The wireless client then communicates with the server process, sending the names of each member of the party and their seating location to the server process. In some embodiments only first names are sent. In some embodiment only naming initials are sent. The wireless client also communicates a unique ID for the client device itself, the unique ID being used to identify this particular wireless client from other wireless clients that may be in use throughout the restaurant. In this way the server process has a listing of all member of the party who are associated with a particular wireless client, their table and seating locations, and the ID of the wireless client with which they are associated. In some embodiments multiple wireless clients may be used by a single party at the restaurant. In some embodiments that entering of table identification values and/or seating identification values are automated using barcode scanners, digital camera image recognition, RF ID tags, and/or some other automatic sensing methods.

Using the methods described herein, the user and his daughter review the updated menu that has been downloaded to the PDA upon the screen of the PDA. The user makes his food selections first and enters them in to the PDA, the food selections including preparation characteristics and service characteristics desired by the user, the selections being associated with the user's name and/or initials or other unique identifier. The user then hands the PDA to his daughter who makes her food selections and enters them into the PDA, the selections being associated with the daughter's name and/or initials or other unique identifier. The food selections along with the preparation characteristics and/or service characteristics are then sent to the server process along with an indication of which member of the party made each of the selections. In some embodiments this is achieved by sending the unique seating location of the member along with that members selections. In other embodiments the server process maintains a listing of the seating locations in memory as indexed by each users name, initials, and/or other unique identifier. In such embodiments the name, initials, and/or other unique identifier may be sent to the server process and the server process determines the seat identification value for that member of the party by indexing the stored listing. Either way, information is communicated from the client device to the server process that indicates not only the food selections, preparation characteristic selections, and service characteristic selections desired, but also indicating the person and/or seating location for which the selections were made. In this way the server process has access to both the table and seat location that are associated with the wirelessly communicated selections.

Upon receipt of the order from the wireless client, the server process updates memory accessible to it, and enters a service request to in the Pending Service Request Queue indicating that table (T 17) needs, for example, bread to be delivered to it. This is an automatic service request that is made when an order is received by a wireless client. By accessing the Attendant ID Seating Correlation Data stored in memory accessible to the server process, the server process identifies an Attendant ID to be associated with the service request. In this case there are two attendants who are responsible for table (T17), one has an Attendant ID=(A012) and the other has an Attendant ID=(A023). To determine which of the two attendants the service request should be assigned to and routed to, the server process accesses the Pending Service Request Queue and compares the number of pending service requests for A012 and A023. It is determined based upon a weighted talley of pending service requests that A023 has less of a pending service burden and so the service request is assigned to Attendant A023. The server process then updates the Pending Service Request Queue, indicating in memory that this new service request has been assigned to A023 and that its status is “pending.” The server process then routes the service request to attendant A023. This is performed by sending a message to a wireless device local to the attendant who has been assigned the ID=A023, the message indicating that BREAD is to be delivered Table T17. The message also indicating the time at which the service request was made. The message along with the initiation time appears upon the screen of the wireless device local to attendant A023. Note, for embodiments such as this one in which each attendant has his or her own wireless device local to him or her, the server maintains a correlation list in memory associating each attendant ID with a unique communication ID for each of the wireless devices used by each of the attendants.

Attendant A023 receives the service request upon his screen, indicating to him that Bread is to be delivered to table T17. He then goes to the kitchen, gets bread, and brings it to the table. If he is unsure which table is T17 he can request a table map upon his wireless PDA device indicating which table is T17. In most cases experienced attendants will memorize the table numbers after working in the restaurant for a short period.

Upon delivering the bread to table T17, the attendant uses the stylus of his PDA to check a box next to the routed service request. Upon checking the box, his PDA sends a message to the server process, indicating that this particular service request was completed. This is communicated as wireless data to the server process. The server process then removes this service request from the Pending Service Request Queue.

Next the customer user in this example finishes the water that was already at his seating location when he arrived at the restaurant. He desires a drink refill on his water. To get this refill he engages his PDA, selecting from a menu of available options that he would like a drink refill. He daughter has not finished her water so he does not make a similar selection for her.

His PDA, the wireless client, responds to his menu selection by running a software routine that communicates the Drink Refill Request to the server process. Also communicated is the table identification value and seat identification value for the user, in this case (T17, B). In other embodiments a wireless client ID and/or party member ID is communicated and the table identification value and seat identification value are accessed from memory of the server as indexed by the wireless client ID and/or party member ID. Either way, the server process is sent appropriate information such that it can determine for which user the Drink Refill Request is associated. In many embodiments of the current invention, service requests are communicated by a Service Request command sent from the client to the server process, the service request command including a service request ID that indicates which particular type of service request it refers to. In this case the Drink Service Request may be communicated as Service Request=S12, for S12 is the unique ID for a drink service request. Also a beverage ID is sent indicating that the particular request is for water. In this way if the user had multiple drinks, for example water and coffee at his seating location, it can be distriguished which drink the refill request was referring to.

Upon receipt of Drink Refill Request from the wireless client of the user, the server process updates memory accessible to it, and begins to enter a service request to in the Pending Service Request Queue indicating that seating location (T17, B) needs a drink refill of water to be delivered to it. By accessing the Attendant ID Seating Correlation Data stored in memory accessible to the server process, the server process identifies that there are two attendants who are responsible for table (T17), one has an Attendant ID=(A012) and the other has an Attendant ID=(A023). To determine which of the two attendants the service request should be assigned to and routed to, the server process accesses the Pending Service Request Queue and compares the number of pending service requests for A012 and A023. At this point in time, it is determined based upon a weighted tally of pending service requests that A012 has less of a pending service burden and so the service request is assigned to Attendant A012. The server process then updates the Pending Service Request Queue, indicating in memory that this new drink refill service request has been assigned to A012 and that its status is “pending.” The server process then routes the service request to attendant A012. This is performed by sending a message to a wireless device local to the attendant who has been assigned the ID=A012, the message indicating that DRINK REFILL of WATER is to be delivered Table T17, Seat B. The message also indicating the time at which the service request was made. The message along with the initiation time appears upon the screen of the wireless device local to attendant A012. Attendant A012 receives the service request upon her screen, indicating to her that a water refill is to be delivered to table T17, seat B. She then goes to the bar, gets a pitcher of water, goes to table T17 and refills the water glass at place setting B. Upon completing the water refill, the attendant presses a button on her PDA to indicate that this particular service request was completed. This is communicated as wireless data back to the server process. The server process then removes this service request from the Pending Service Request Queue.

In other embodiments of the present invention when the Pending Service Request Queue is long, an attendant may need to complete a number of prior service requests before getting to the one made by a particular user, such as the user in the example above.

For example attendant A012 may have four previously pending service requests ahead of the service request from table T17 seat B. In such a case, the software of the server process can be configured to send a QUEUE NUMBER to the wireless client of the user who made a request, the QUEUE NUMBER indicating the number of pending requests in line before the user's request (or the request number that the user's request is in the listing of received requests). The QUEUE NUMBER is displayed to the user upon his PDA, thereby indicating how many service requests must be served by the assigned attendant before that attendant services his request. In the example above, if there were four service requests pending for attendant A012 prior to the service request made by the user at table T17, seat B, the queue number “5” is displayed to that user as sent to his wireless client by the server process, letting the user know that he is fifth in the service cue for that attendant. As the attendant completes her prior service request, the queue number 5 is updated, going to 4 and then 3 and then 2. Finally the queue number disappears indicating that the server is now working on that customer's service request. Instead of the number disappearing, in some embodiments it is replaced by the phrase “In Process.” In this way a user can make a request for an attendant in a restaurant to perform a service request at his table, such as refill a drink or clear dishes or bring a next course and that user can be given feedback as to the backlog of pending service requests and thereby be empathetic of the time required for an attendant to complete the request.

As demonstrated by the description and example above, the inventive method and apparatus and software instructions disclosed herein allows for customer of a restaurant to communicate wirelessly with one or more attendants of a restaurant, making service requests of the attendants. The description of the present invention has been presented for purposes of illustration and description, and is not intended to be exhaustive or limited to the invention in the form disclosed. Modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

It is claimed:

1. An apparatus for electronic customer-attendant interaction in a food service establishment, said apparatus comprising:
a computer server, said computer server comprising: a programmable central processing unit, a memory unit, a server wireless network interface, a peripheral interface; and wherein said processing unit is operatively connected to said memory unit; and wherein said processing unit is operatively connected to said server wireless network interface; and wherein said processing unit is operatively connected to said peripheral interface;
a plurality of personal computing devices; said personal computing devices each having a personal computing device wireless network interface; and
wherein said server wireless network interface and each personal computing device wireless network interface are operatively connected; such that
food service information is sent from the computer server to the personal computing devices and service requests are sent from the personal computing devices to the computer server.

2. The apparatus as in claim 1, wherein a table identification value is sent from each personal computing device to said server so as to identify the current table of its user within the food service establishment.

3. The apparatus as in claim 2, wherein a seat identification value is sent from each personal computing device to said server so as to identify the current seat of its user within the food service establishment.

4. The apparatus as in claim 1, wherein the service requests includes a drink refill request.

5. The apparatus as in claim 4, wherein the drink refill request includes a drink type identifier.

6. The apparatus as in claim 1, wherein one or more of the service requests includes a unique User Identifier that indicates which person at a particular table the particular service request relates to.

7. The apparatus as in claim 1, wherein the food service information includes current preparation status update information for one or more food items ordered by a user of the particular personal computing device.

8. The apparatus as in claim 1, wherein one or more of the service requests includes a waiter request comprising a general request that a live attendant visit a table that is relationally associated with the request.

9. The apparatus of claim 1, wherein the user of a personal computing device manually entered a table identification value and/or seat identification value into the device through a user interface of the device.

10. The apparatus of claim 1, wherein a wireless information reader is used by a personal computing device to determine the table and/or seat of the food service establishment currently being used by a user of that personal computing device.

11. The apparatus as in claim 10 wherein said portable digital assistant further comprises a barcode reader, said barcode reader reading the table identification and the seat identification from a barcode label.

12. The apparatus as in claim 10 wherein said portable digital assistant further comprises a Radio Frequency Identification reader, said Radio Frequency Identification reader reading the table identification and the seat identification from a Radio Frequency Identification tag.

13. The apparatus as in claim 10 wherein said portable digital assistant further comprises a camera, said camera reading a table identification and seat identification from a label.

14. The apparatus of claim 1 wherein said computer server is operative to identify a human attendant to service each of said received service requests.

15. The apparatus of claim 14 wherein said computer server is operative to forward a representation of a received service request to an identified human attendant by sending an electronic message to a wireless device on the person of that human attendant.

16. The apparatus of claim 15, wherein said electronic message includes a table identification value indicating a table within said food service establishment that is relationally associated with said received service request.

17. The apparatus of claim 16, wherein said electronic message includes a time-stamp that is relationally associated with said received service request.

18. The apparatus of claim 14, wherein said computer server is operative to compare the pending task loads of a plurality of human attendants when identifying a particular human attendant to service a particular received service request.

19. The apparatus of claim 14, wherein said computer server is operative to identifying said human attendant to service a particular received service request based at least in part upon a match between a table identification value relationally associated with the particular received service request and a table identification value and/or range of table identification values relationally associated with that particular human attendant.

20. A method of providing food service to a customer in a food service establishment, the method comprising:
receiving a table identification value and/or a seat identification value over a wireless network from a customer using a personal computing device;
receiving a food service request over a wireless network from a customer using a personal computing device; and
instructing a human attendant to service said food service request, said instructing including informing said human attendant as to the nature of the food service request and the table for which the food service request is relationally associated.

21. The method of claim 20 wherein said instructing said human attendant comprises sending an electronic message over a wireless communication link to a personal computing device on the person of said human attendant.

22. The method of claim 20 wherein the service requests comprises a drink refill request.

23. The method of claim 21 wherein the drink refill request includes a drink type identifier.

24. The method of claim 20 wherein the service requests comprises a bread refill request.

25. The method of claim 20 wherein said service requests includes a unique User Identifier that indicates which person at a particular table the service request relates to.

26. The method of claim 20 wherein said human attendant is selected from a plurality of human attendants based at least in part upon a computed task load associated with each of said plurality of human attendants.

27. The method of claim 20 wherein said human attendant is selected from a plurality of human attendants based at least in part upon a match between a table identification value relationally associated with the service request and a table identification value and/or range of table identification values relationally associated with the human attendant.

28. The method of claim 20 wherein said human attendant is relationally associated with a unique attendant ID.

29. The method of claim 20 further including the step of maintaining a queue of a plurality of pending received service requests.

30. The method of claim 20 further including the step of receiving an electronic message from an attendant indicating that a particular service request has been serviced.

31. The method of claim 30 further including the step of removing a received service request from a queue of received service requests in response to receiving an electronic message from an attendant indicating that the service request has been serviced.

32. The method of claim 20 wherein current preparation status update information is sent to a personal computing device for to one or more food items ordered by a user of that personal computing device.
